(19) United States
(12) Patent Application Publication
(10) Pub. No.: US 2025/0030208 A1
(43) Pub. Date: Jan. 23, 2025

(54) REAR-MOUNTABLE CONNECTOR HOUSING

(71) Applicant: HARTING ELECTRIC STIFTUNG & CO. KG, Espelkamp (DE)

(72) Inventor: Albert FERDERER, Espelkamp (DE)

(21) Appl. No.: 18/716,490

(22) PCT Filed: Nov. 25, 2022
(86) PCT No.: PCT/DE2022/100882

§ 371 Date: Jun. 4, 2024

(30) Foreign Application Priority Data
Dec. 6, 2021 (DE) 10 2021 132 062.3

(51) Int. Cl. H01R 13/73; H01R 13/518

(52) U.S. Cl. CPC H01R 13/73; H01R 13/518

(57) ABSTRACT

An add-on housing and method for installing an add-on housing is provided for securing to a device wall of an electrical device, the add-on housing having a frame-shaped basic shape which encloses a receiving region for receiving a contact insert or a holding frame fitted with plug-in connector modules, wherein at least two fastening surfaces having fastening openings are integrally formed on the outside of the frame-shaped basic shape, a depression being formed within the fastening surfaces and fastening openings being arranged in each depression, wherein the add-on housing has snap-fastening means which engage through the fastening openings to mechanically fasten the add-on housing to a through-hole in a device wall.

### BACKGROUND

### Technical Field

Embodiments of the present disclosure relate to an add-on housing and a method for installing an add-on housing.

Such add-on housings are used in an industrial context. The add-on housings accommodate a contact insert or a retaining frame which is equipped with plug connector modules and supplies the relevant devices with electrical energy and/or signals.

### Description of the Related Art

The document DE 10 2020 101 812 A1 discloses an add-on housing with a frame-shaped basic shape which encloses a receiving region for receiving a contact insert or a retaining frame equipped with plug connector modules, wherein at least two fastening surfaces with fastening openings are integrally formed on the outside of the frame-shaped basic shape, wherein the add-on housing has snap-fastening means which engage through the fastening openings in order to mechanically fasten the add-on housing to a wall orifice of a device wall.

Such add-on housings can be fitted on the outside of a device or its housing. However, in some cases it is necessary for cabling reasons to assemble a plug connector housing inside a housing and push it outward from inside, through an aperture of the housing, and fix it on the housing.

The German Patent and Trademark Office has conducted a search in the priority application to the present application and found the following prior art: DE 10 2013 004 551 A1, DE 10 2020 101 812 A1, and US 2007/0241256 A1.

### BRIEF SUMMARY

Embodiments of the disclosure provide an add-on housing which can be installed and maintained simply.

So-called rear mounting is possible by virtue of the add-on housing described herein. This means that the add-on housing is pushed outward from the inside of a device and/or a machine and can be fastened reversibly. Pre-assembled cables can be used here. More assembly options are consequently provided for the device or machine producer.

The add-on housing described herein has a frame-shaped basic shape with a rectangular cross-section. The peripheral raised frame wall extends substantially perpendicularly to the device wall.

The add-on housing has a receiving region for receiving a contact insert or a retaining frame equipped with plug connector modules. This receiving region is enclosed or protected by the abovementioned frame wall. The receiving region can be closed with the aid of a housing cover when no plug connector is connected.

The add-on housing can have a locking clip via which a connected plug connector can be fixed reversibly.

At least two fastening surfaces with fastening openings are integrally formed on the frame-shaped basic shape of the add-on housing. The fastening surfaces are provided on the narrow sides of the add-on housing.

The add-on housing can be mechanically fastened to a wall orifice of a device wall with the aid of snap-fastening means or devices which engage through the fastening openings. Using the snap-fastening means or devices, the add-on housings can be fitted on a device wall without the use of tools, which makes the fitting process as a whole easier and quicker. For maintenance purposes, for example in order to replace a seal, the add-on housings can be removed again simply from the device wall and then fastened back onto it just as simply.

Depressions are provided in the fastening surfaces of the add-on housing. The material thickness of the fastening surface is designed as thinner in this region. The fastening openings are arranged in each case inside these depressions.

The snap-fastening means or devices each have a box-shaped basic body with a rectangular cross-section. Spring-mounted foot parts protrude from the opposite narrow faces of the box-shaped basic body. The spring mounting is implemented via a spiral spring.

When the snap-fastening means devices are inserted fully into the fastening openings, end stops are supported on the outside of the device wall, whilst the foot parts are supported on the inside of the fastening surface of the add-on housing, as a result of which the add-on housing is fastened to the device wall.

The foot parts of the snap-fastening means or devices are spring-mounted. The spring force is directed such that the foot parts are constantly pushed out of the box-shaped basic body. If the foot parts are pressed, counter to the spring force, into the box-shaped basic body of the snap-fastening means or devices, the add-on housing can be removed again from the device wall.

In some embodiments, the snap-fastening means or devices may have a mechanism, accessible via its outward facing surface, by which the foot parts can be guided inward (back into the box-shaped basic body), counter to the spring force. As a result, the add-on housing can be removed again from the device wall without having to access the inside of the device. This further increases the easy maintenance of the add-on housing.

In some embodiments, the fastening openings of the add-on housing may be designed as rectangular, in a similar way to the cross-section of the snap-fastening means or devices. The fastening opening is here configured as only slightly larger than the cross-section of the snap-fastening means or devices. Such fastening openings can be formed easily from a manufacturing point of view, for example by punching.

The fastening openings advantageously each have a peripheral seal such that no undesired media such as dust and water can penetrate inside the device.

The add-on housing is pushed outward from the inside of a device housing through a wall orifice provided for this purpose such that a plug connector can be plugged onto the outside of the add-on housing. The fastening surface of the add-on housing is thus pressed against the inside of the device wall. In some embodiments, a seal may be arranged between the fastening surface and the device wall.

The snap-fastening means or devices are pushed into the fastening openings from the outside. The snap-fastening means or devices have end stops which bear against the outside of the device wall. In some embodiments, a seal may be arranged between the end stops and the device wall.

The foot parts of the snap-fastening means or devices each have a first oblique surface and a second oblique surface. The externally visible part of the foot parts have an essentially triangular cross-section. In the fully inserted, locked state, the second oblique surface is supported on the depressions in the frame-shaped basic shape of the add-on housing. The second oblique surface here stands at an acute angle to the plane of the depression. By virtue of the above described active connection of the foot part to a spring, a force directed essentially outward (orthogonally to the depression) is permanently exerted by the foot part on the depression surface or depression plane, as a result of which secure fixing of the add-on housing is ensured.

### BRIEF DESCRIPTION OF THE SEVERAL VIEWS OF THE DRAWINGS

An embodiment of the disclosure is illustrated in the drawings and explained in detail below.

FIG. 1 shows a perspective illustration of an add-on housing.

FIG. 2 shows a perspective illustration of a snap-fastening means or devices.

FIG. 3 shows a simplified side view of the snap-fastening means or devices.

FIG. 4 shows an illustration in section of the add-on housing in the fastening region.

### DETAILED DESCRIPTION

The Figures contain partially simplified schematic illustrations. Identical reference signs are in some cases used for the same but possibly non-identical elements. Different views of the same elements can be at a different scale. Specified directions such as “left”, “right”, “up”, and “down” are to be understood with reference to the respective figure and can vary in the individual illustrations from the object illustrated.

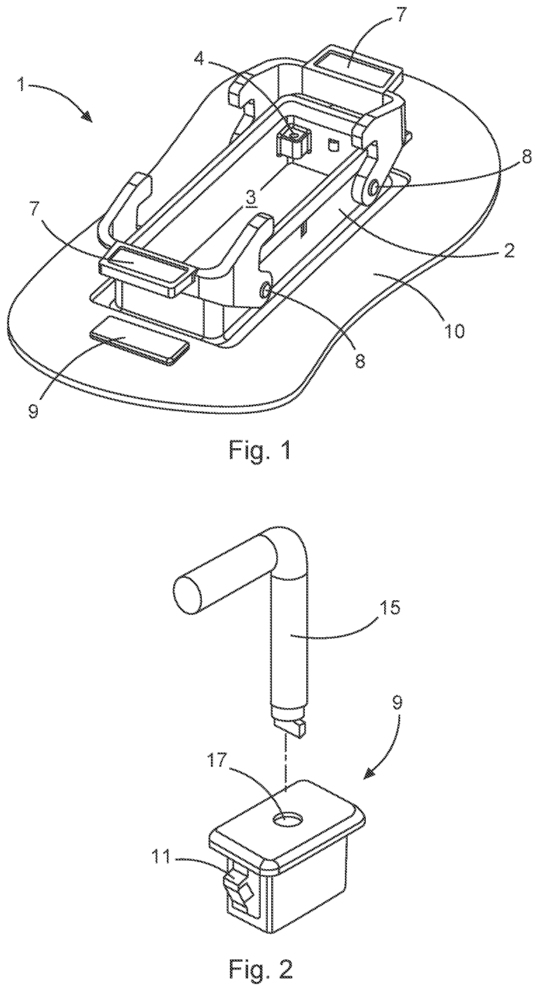

An add-on housing 1 is shown in a perspective view in FIG. 1. The add-on housing 1 has a frame-shaped basic shape 2 with a receiving region 3. A contact insert or a retaining frame equipped with plug connector modules is fastened in the receiving region 3. Screw openings 4 are provided for this purpose in the corner regions of the receiving region 3. For illustrative reasons, no contact insert or equipped retaining frame is shown in the Figures.

Two fastening surfaces 5 are integrally formed on the frame-shaped basic shape 2. In each case one rectangular fastening opening 6 is provided in the fastening surfaces 5. The fastening surfaces 5 project from the outside of the frame-shaped basic shape 2 and are arranged, for example, perpendicularly to the latter.

In the upper region of the narrow sides of the frame-shaped basic shape 2, locking clips 7 are pivotably mounted on pins 8 integrally formed on the wide sides.

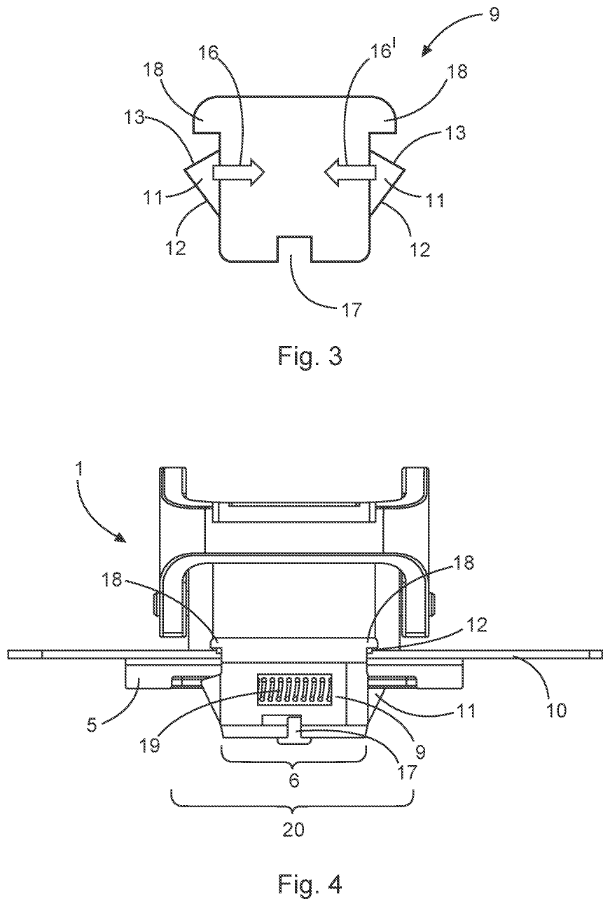

Shown in FIGS. 2 and 3 is the snap-fastening means or devices 9 by which the add-on housing 1 can be reversibly fastened to a device wall 10. The outward facing surface of the box-shaped basic body has a tool opening 17. By inserting a tool 15 into this tool opening 17, foot parts 11 can be retracted into the inside of the basic body in the direction of arrows 16, 16′ via a mechanism which is not shown. The add-on housing 1 can then be removed from the device wall 10. Conventional screwdrivers or Allen keys, which most industrial mechanics always have on hand, can, for example, be used as the tool.

An illustration in section of the add-on housing 1 in the fastening region can be seen in FIG. 4. The add-on housing 1 is pushed outward from the inside of a device through a wall orifice. At least two fastening openings 6 of the add-on housing 1 here correlate with corresponding fastening openings in the device wall 10. Snap-fastening means or devices 9 are pushed inward from outside into the aligned fastening openings of the add-on housing 1 and the device wall 10. As a result, the add-on housing 1 is reversibly fixed on the device wall 10.

When the add-on housing 1 is fastened to the device wall 10, snap-fastening means or devices 9 are arranged in the fastening openings 6. Seals, which prevent the penetration of media into the device housing, are provided in the fastening openings 6.

The snap-fastening means or devices 9 have a box-shaped basic body, wherein foot parts 11 which are spring-mounted via a spiral spring 19 and are supported on the device wall 10 protrude from the opposite narrow faces of the box-shaped basic body. Each respective foot part 11 has a first oblique surface and a second oblique surface 13, wherein, in the fixed state, the second oblique surface 13 is supported against the inner side of the device wall 10. On the other side of the device wall 10, end stops 18 of the snap-fastening means or devices 9 are supported on the outer side of the device wall 10. A seal 12 is arranged between the end stops 18 and the device wall 10.

In the fixed state, the device wall 10 and the second oblique surface stand at an acute angle relative to each other. By virtue of the spring mounting of the foot parts 11, the latter are constantly pushed outward in the direction of an arrow 14. The second oblique surface 13 consequently pushes permanently against the device wall 10. As a result, secure fixing of the add-on housing 1 on the device wall 10 is ensured.

The tolerance range of the contact pressure can be enlarged or reduced by changing the angle or the oblique surface. The contact pressure of the add-on housing against the housing or device wall can also be varied by the pretensioning force of the spring.

Even if different aspects or features of the invention are in each case shown in combination in the figures, it is apparent to a person skilled in the art, unless stated otherwise, that the combinations illustrated and discussed are not the only possible ones. In particular, mutually corresponding units or groups of features from different exemplary embodiments can be exchanged with one another.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An add-on housing for fastening to a device wall of an electrical device, the add-on housing, comprising:
a frame-shaped basic shape that encloses a receiving region, wherein the receiving region is configured to receive a contact insert or a retaining frame equipped with plug connector modules,
wherein at least two fastening surfaces are integrally formed on an outside of the frame-shaped basic shape,
wherein a respective depression is formed inside each respective fastening surface and a respective fastening opening is arranged in each depression, and
wherein the add-on housing has snap-fastening devices configured to engage through the fastening openings to mechanically fasten the add-on housing to a wall orifice of a device wall.

2. The add-on housing as claimed in claim 1, wherein a material thickness in a region of the depressions is smaller than in a region of the remainder of each respective fastening surface.

3. The add-on housing as claimed in claim 1, wherein the snap-fastening devices have end stops which bear against an outside of the device wall when the add-on housing is installed.

4. The add-on housing contact element as claimed in claim 1, wherein the snap-fastening devices have foot parts supported on an inside of the device wall when the add-on housing is installed.

5. The add-on housing as claimed in claim 4, wherein a seal is arranged between the end stops and the device wall when the add-on housing is installed.

6. A method for fastening an add-on housing to a wall aperture of a device wall, the method comprising:
pushing the add-on housing outward from an inside of a peripherally closed device housing through the wall aperture, provided for this purpose, wherein the add-on housing has fastening openings which are aligned with corresponding fastening openings in the device wall; and
inserting snap-fastening devices with a box-shaped basic body and with laterally projecting opposite spring-mounted foot parts into the aligned fastening openings of the add-on housing and the device wall,
wherein the foot parts, when inserted into the fastening openings, are first pressed into the box-shaped basic body and are then supported on the device wall.
